(19) United States
(12) Patent Application Publication
(10) Pub. No.: US 2026/0011125 A1
(43) Pub. Date: Jan. 8, 2026

(54) DATA SELECTION DEVICE AND DATA SELECTION PROGRAM

(71) Applicant: TOYOTA JIDOSHA KABUSHIKI KAISHA, Toyota-shi Aichi-ken (JP)

(72) Inventor: Lukasz Kamil Majewski, Chiba-shi Chiba-ken (JP)

(73) Assignee: TOYOTA JIDOSHA KABUSHIKI KAISHA, Toyota-shi Aichi-ken (JP)

(21) Appl. No.: 19/254,610

(22) Filed: Jun. 30, 2025

(30) Foreign Application Priority Data
Jul. 4, 2024 (JP) 2024-108167

(51) Int. Cl. G06V 10/774; G06V 10/74

(52) U.S. Cl. CPC G06V 10/774; G06V 10/761

(57) ABSTRACT

A data selection device for selecting image data for training of a prediction model which outputs data relating to an instance in an image represented by the image data when the image data is input includes a processor. The processor is configured to: extract an instance whose degree of coincidence between output data of the prediction model when the annotated image data is input to the prediction model and the ground truth value regarding the instance of the annotated image data is equal to or less than a predetermined value; extract image data including an instance whose similarity with the extracted instance is equal to or greater than a predetermined value from a plurality of pieces of image data which are not annotated and which is a candidate of image data for training; and select at least a part of extracted image data as image data for training.

### CROSS-REFERENCE TO RELATED APPLICATIONS

This application claims priority to Japanese Patent Application No. 2024-108167 filed Jul. 4, 2024, the entire contents of which are herein incorporated by reference.

### FIELD

The present disclosure relates to a data selection device and a data selection program.

### BACKGROUND

Conventionally, training data is created in order to perform machine learning of a prediction model (JP2020-126311A, JP2023-38990A, JP2020-154564A). In creating the training data, an annotation is performed on an object included in the images (JP2020-126311A, JP2023-38990A). In particular, in an annotation device described in JP2020-126311A, when the labels are similar to each other, the labels are displayed on the operation screen in an separated manner from each other so that the operator does not erroneously apply the labels in the manual annotation operation.

The data includes data that is effective for training the prediction model and data that is ineffective therefor. Therefore, if the annotation is performed without considering the effectiveness of the training, the annotation is also performed on the data that is not effective for the training of the prediction model, and as a result, the man-hour of the annotation performed manually is unnecessarily increased. Further, even if the training of the prediction model is performed using the training data created blindly, a high training effect is not always expected.

### SUMMARY

In view of the above-described problems, an object of the present disclosure is to improve a training effect by the created training data while reducing the man-hours of annotation.

The gist of the present disclosure is as follows.
(1) A data selection device for selecting image data for training of a prediction model which outputs data relating to an instance in an image represented by the image data when the image data is input, the data selection device comprising a processor,
   the processor is configured to:
   extract an instance whose degree of coincidence between output data of the prediction model when the annotated image data is input to the prediction model and the ground truth value regarding the instance of the annotated image data is equal to or less than a predetermined value;
   extract image data including an instance whose similarity with the extracted instance is equal to or greater than a predetermined value from a plurality of pieces of image data which are not annotated and which is a candidate of image data for training; and select at least a part of extracted image data as image data for training.
(2) The data selection device according to above (1), wherein
   the prediction model is a model which outputs a prediction result regarding an instance in an image represented by the input image data and a reliability thereof, and
   the processor is configured to:
   input each extracted image data to the prediction model to output the reliability; and
   select at least a part of image data including an instance whose reliability is equal to or less than a predetermined first reference value, as image data for training.
(3) The data selection device according to above (2), wherein
   the processor is configured to select at least a part of image data including an instance whose reliability is equal to or less than the first predetermined reference value, and is equal to or greater than the second predetermined reference value, as image data for training, and
   the first reference value is greater than the second reference value.
(4) The data selection device according to above (1), wherein
   the prediction model has a plurality of candidate models which output a prediction result relating to an instance in an image represented by the input image data and reliability thereof,
   the processor is configured to:
   input each extracted image data to each candidate model to output the reliability, and
   select, as the image data for training, image data including an instance in which an average value of obtained reliability in all the candidate models or a obtained reliability in at least one of the candidate models is within a predetermined range.
(5) A non-transitory computer readable medium having recorded thereon a data selection program for selecting image data for training of a prediction model which outputs data relating to an instance in an image represented by the image data when the image data is input, the data selection program causing a computer to execute a process comprising:
   extracting an instance whose degree of coincidence between output data of the prediction model when the annotated image data is input to the prediction model and the ground truth value regarding the instance of the annotated image data is equal to or less than a predetermined value;
   extracting image data including an instance whose similarity with the extracted instance is equal to or greater than a predetermined value from a plurality of pieces of image data which are not annotated and which is a candidate of image data for training; and
   selecting at least a part of extracted image data as image data for training.

### BRIEF DESCRIPTION OF DRAWINGS

FIG. 1A is a diagram schematically illustrating an example of image data input to a prediction model.

FIG. 1B is a diagram schematically illustrating an example of an output of a prediction model.

FIG. 2 is a configuration diagram schematically illustrating a data selection device according to a first embodiment.

FIG. 3A is a diagram illustrating an example of image data input to the prediction model in an instance extraction unit.

FIG. 3B is a diagram illustrating an example of an output of the prediction model.

FIG. 4 is a diagram illustrating an example of an instance extracted by the instance extraction unit.

FIG. 5 is a diagram illustrating an example of an image represented by image data extracted by a similar data extraction unit.

FIG. 6 is a flowchart illustrating a flow of a data selection process executed in the data selection device according to the first embodiment.

FIG. 7 is a flowchart illustrating a flow of a data selection process executed in the data selection device according to a second embodiment.

### DESCRIPTION OF EMBODIMENTS

Hereinafter, embodiments will be described in detail with reference to the drawings. In the following description, the same reference numerals are given to the same components.

### First Embodiment

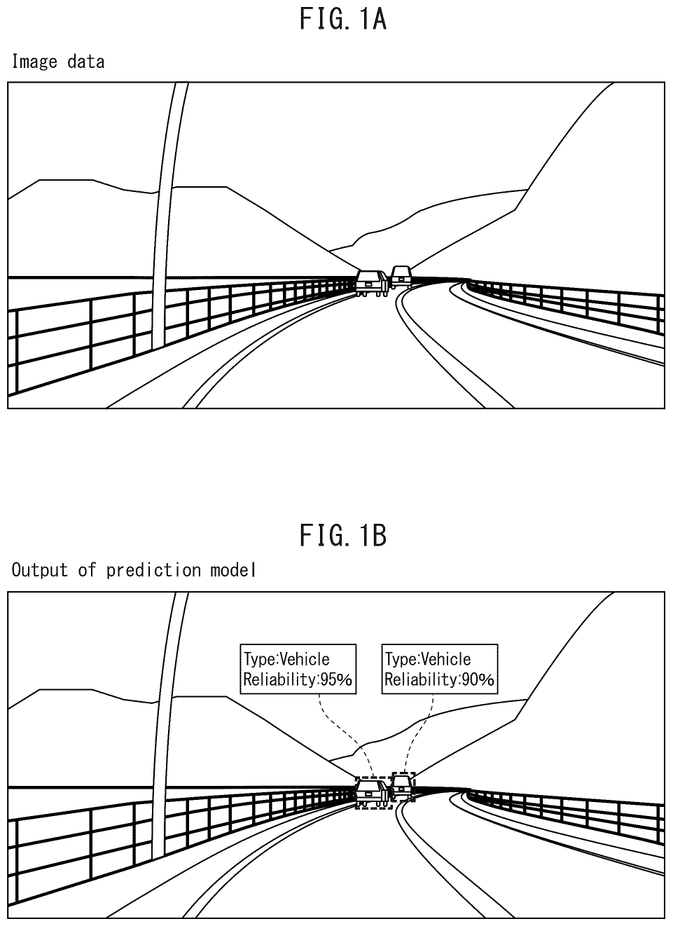

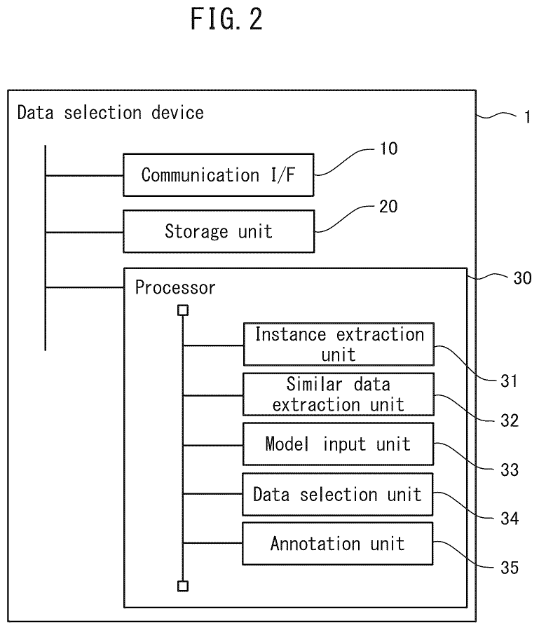

First, the data selection device 1 according to the first embodiment will be described with reference to FIGS. 1A, 1B and 2. The data selection device 1 selects image data for training of a prediction model from a plurality of pieces of image data.

In describing the data selection device 1, first, a prediction model will be explained. In the present embodiment, the prediction model is a model that outputs data related to an instance (for example, an object) in an image represented by the image data when the image data is input. For example, when image data is input, the prediction model outputs a prediction result (for example, a position, a type, or the like of an object) relating to an instance in the image represented by the image data and a reliability relating to the prediction result.

In particular, in the present embodiment, data of an image in front of a vehicle captured by an outside camera attached to the vehicle is input to the prediction model. Then, the prediction model outputs the position, type, and reliability of an object (for example, a surrounding vehicle, a pedestrian, a road, a demarcation line, a sign, an obstacle on a road, or the like) included in the image represented by the input image data.

FIGS. 1A and 1B are diagrams schematically illustrating examples of image data input to the prediction model and an output of the prediction model. FIG. 1A illustrates an example of an image represented by image data input to a prediction model. As illustrated in FIG. 1A, image data of an image in front of a vehicle captured by the outside camera of the vehicle during traveling is input to the prediction model.

FIG. 1B illustrates an example of output data output by the prediction model when the image data representing the image illustrated in FIG. 1A is input to the prediction model. In the example illustrated in FIG. 1B, the recognition processing of an instance is performed by the prediction model, and the position of the instance of the vehicle included in the image or the like is output. In particular, in the example illustrated in FIG. 1B, the image captured by the outside camera includes images of two vehicles, and the prediction model outputs the respective positions of the instances of the vehicles as positions surrounded by dashed squares in the drawing. Further, in the example illustrated in FIG. 1B, the type of the instance and the reliability regarding the instance are output for each of the images of the vehicle by the prediction model. In the example illustrated in FIG. 1B, although the prediction result and the reliability are exemplarily represented in the image, the prediction result and the reliability are not actually represented in the image.

In the example illustrated in FIGS. 1A and 1B, when image data of one image is input to the prediction model, the position, type, and reliability of an arbitrary instance included in the image are output. However, when image data of a continuous series of images (moving images) is input, the prediction model may output the position of any instance included in each of the images. Hereinafter, a case in which image data of one image is input to the prediction model will be described as an example, but the present disclosure is also applicable to a case in which image data of a series of consecutive images is input to the prediction model.

In order to train such a prediction model, training data used for training of the prediction model is required. The training data is data including an image of the front of the vehicle captured by the outside camera and a ground truth value regarding an instance included in the image. Specifically, the training data is data including, for example, an image (an image as shown in FIG. 1A) of the front of the vehicle captured by the outside camera and a ground truth value (ground truth label) representing the position and type of each instance included in the image.

Such training data is generated by manual annotation. That is, training data is generated by manually giving, to an image in front of the vehicle captured by the outside camera, a ground truth value regarding an instance included in the image. The data selection device 1 according to the present embodiment is used to select image data to be annotated, that is, image data for training of a prediction model, from a plurality of pieces of image data of images captured by the outside camera.

Next, a configuration of the data selection device 1 according to the first embodiment will be described with reference to FIG. 2. FIG. 2 is a configuration diagram schematically illustrating the data selection device 1 according to the first embodiment.

As illustrated in FIG. 2, the data selection device 1 includes a communication interface 10, a storage unit 20, and a processor 30. Note that the communication interface 10, the storage unit 20, and the processor 30 may be separate circuits or may be configured as one integrated circuit.

The communication interface 10 is an interface circuit for connecting the data selection device 1 to an external device of the data selection device 1. The data selection device 1 transmits and receives data to and from an external device via the communication interface 10. The external device includes, for example, an outside camera of any vehicle 100, or a vehicle storage device (not shown) that stores data of an image captured by such an outside camera. Further, the external device includes a training device that causes a machine learning model to be trained. In addition, the external device may include an input device (e.g., keyboard, mouse, etc.) by the user and an output device (e.g., display, speaker, etc.) to the user. In the present embodiment, the communication interface 10 receives, from the outside camera or the vehicle storage device of the vehicle, the data of the image in front of the vehicle captured by the outside camera while the vehicle is traveling, and stores the data in the storage unit 20. Further, the communication interface 10 transmits the image data for training, selected by the data selection device 1 and then annotated to the training device.

The storage unit 20 is a non-transitory storage medium that stores data. The storage unit 20 includes, for example, at least one of a volatile semiconductor memory, a nonvolatile semiconductor memory, a hard disk drive (HDD), and a solid state drive (SSD). The storage unit 20 stores a computer program executed by the processor 30, in particular, a data selection program for executing a data selection process. Further, the storage unit 20 stores data used in a computer program executed by the processor 30, such as data of an image in front of the vehicle received from the outside via the communication interface 10. In addition, the storage unit 20 stores data of the training image selected by the processor 30 and annotated.

The processor 30 comprises one or more CPU (Central Processing Unit) and its peripheral circuitry. The processor 30 may further include other arithmetic circuits such as a logical arithmetic unit or a numerical value arithmetic unit. The processor 30 executes a computer program stored in the storage unit 20. In particular, in the present embodiment, the processor 30 executes the data selection program stored in the storage unit 20.

As illustrated in FIG. 2, the processor 30 includes an instance extraction unit 31, a similar data extraction unit 32, a model input unit 33, a data selection unit 34, and an annotation unit 35. These units included in the processor 30 are, for example, functional modules realized by a computer program running on the processor 30. Alternatively, each unit of the processor 30 may be implemented in the data selection device 1 as an independent integrated circuit, microprocessor, or firmware.

The instance extraction unit 31 extracts an instance in which the degree of coincidence between the output of the prediction model when the annotated image data is input to the prediction model and the ground truth value regarding the instance of the annotated image data is equal to or less than a predetermined reference value. Here, the annotated image data is image data including, in addition to the image data, ground truth values related to the instances included in the image represented by the image data.

Here, the storage unit 20 stores a plurality of annotated image data. The image represented by the annotated image data includes various types of instances. The image represented by one image data does not necessarily have to include a plurality of types of instances. However, the entire annotated image data stored in the storage unit 20 includes most types of instances appearing in images captured by the vehicle.

The instance extraction unit 31 inputs the annotated image data stored in the storage unit 20 to the prediction model to be trained. When the image data is input, the prediction model outputs the prediction result relating to the instance in the image represented by the image data and the reliability thereof.

Then, the instance extraction unit 31 calculates the degree of coincidence between the prediction result output in this way and the ground truth value included in the annotated image data. For example, when the position and type of the instance output by the prediction model coincide with the ground truth value of the position and type of the instance, the instance extraction unit 31 calculates the degree of coincidence high. On the other hand, for example, when the position and type of the instance output by the prediction model do not coincide with the ground truth value of the position and type of the instance, the instance extraction unit 31 calculates the degree of coincidence low. In addition, even when the position and type of the instance output by the prediction model coincide with the ground truth value of the position and type of the instance, the instance extraction unit 31 may calculate the degree of coincidence lower when the reliability is low than when the reliability is high. In addition, for example, when the position or the type of the instance output by the prediction model does not match the ground truth value of the position and the type of the instance, the instance extraction unit 31 may calculate the degree of coincidence lower when the reliability is high than when the reliability is low.

Thereafter, when the degree of coincidence calculated in this manner for an arbitrary instance is equal to or less than a predetermined reference value, the instance extraction unit 31 extracts the instance as an instance with a low degree of coincidence. In this way, the instance with a low degree of coincidence represents an instance with a low prediction accuracy in the prediction model.

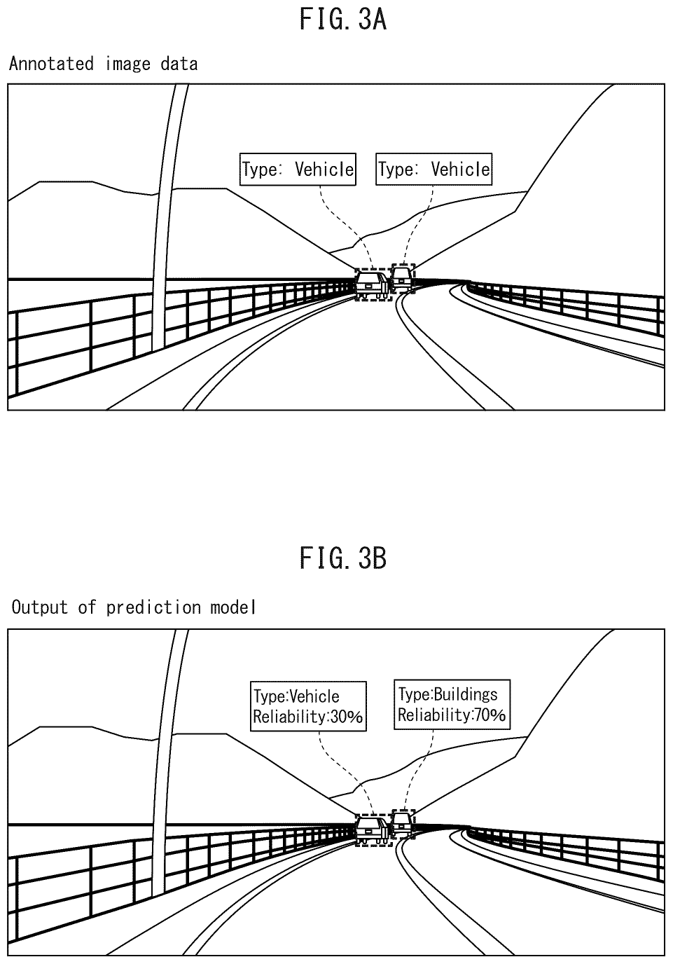

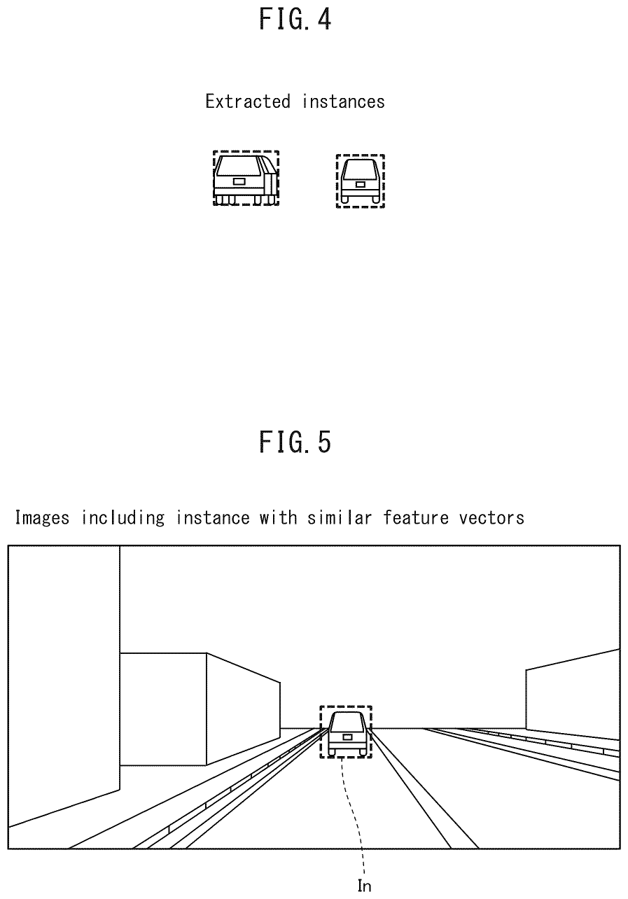

FIGS. 3A and 3B are diagrams illustrating examples of an image represented by image data input to the prediction model in the instance extraction unit 31 and output of the prediction model. FIG. 3A illustrates an example of an image represented by annotated image data input to the prediction model. In the example illustrated in FIG. 3A, the annotated image data includes ground truth values of positions and types of instances of two vehicles included in the image. On the other hand, FIG. 3B shows the output of the prediction model when the image data shown in FIG. 3A is input to the prediction model. In the example illustrated in FIG. 3B, although the type of the instance of one of the vehicles is correctly determined to be the vehicle, the reliability thereof is low. Therefore, in the example illustrated in FIGS. 3A and 3B, the instance extraction unit 31 determines that the degree of coincidence for the instance of the one of the vehicles is equal to or less than the reference value, and extracts the instance as an instance with a low degree of coincidence. In addition, in the example illustrated in FIG. 3B, it is erroneously determined that the type of the instance of the other of the vehicles is a building. Therefore, in the example illustrated in FIG. 3, the instance extraction unit 31 determines that the degree of coincidence for the instance of the other of the vehicles is equal to or less than the reference value, and extracts the instance as an instance with a low degree of coincidence. FIG. 4 shows an example of the instance extracted by the instance extraction unit 31 in this manner.

The similar data extraction unit 32 extracts image data including an instance having a degree of similarity equal to or greater than a predetermined value with the instance extracted by the instance extraction unit 31 from a plurality of unannotated image data that are candidates for image data for training. In the present embodiment, the similar data extraction unit 32 extracts the image data including the instance having the feature approximate to the feature of the instance extracted by the instance extraction unit 31 by a similarity search. In particular, in the present embodiment, the similar data extraction unit 32 extracts image data including an instance having a feature vector whose distance from the feature vector of the instance extracted by the instance extraction unit 31 is equal to or less than a predetermined reference distance.

The similar data extraction unit 32 first calculates the feature vector of the instance extracted by the instance extraction unit 31. The feature vector is calculated by inputting the image data of the instance extracted by the instance extraction unit 31 to an arbitrary encoder. The encoder is, for example, a neural network that outputs a feature vector corresponding to image data of an instance when the image data of the instance is input.

Thereafter, the similar data extraction unit 32 recognizes an instance represented in each of the plurality of images that are not annotated, and calculates a feature vector of the recognized instance. The recognition of the instance is performed by inputting each image into the instance recognition model. The instance recognition model is, for example, a neural network that outputs a position of an arbitrary instance included in an image represented by the image data when the image data is input. In addition, for example, the above-described encoder is used for calculating the feature vector.

Then, the similar data extraction unit 32 calculates a distance (e.g., Euclidean distance or Manhattan distance) between the feature vector of the instance extracted by the instance extraction unit 31 and the feature vector of the instance included in each image that is not annotated. Then, the similar data extraction unit 32 extracts image data having an instance in which the calculated distance is equal to or less than a predetermined reference distance from the plurality of images that are not annotated.

FIG. 5 is a diagram illustrating an example of an image represented by image data extracted by the similar data extraction unit 32. In the example illustrated in FIG. 5, the feature vector of the instance In surrounded by the dashed square in the drawing has the distance from the feature vector of the instance extracted by the instance extraction unit 31 illustrated in FIG. 4, which is equal to or less than the reference distance. Therefore, the image data of the image shown in FIG. 5 including the instance In is extracted by the similar data extraction unit 32.

In the present embodiment, the similar data extraction unit 32 extracts image data including instances having high similarity using the distance of the feature vector. However, as long as image data including an instance having a high degree of similarity can be extracted, the image data may be extracted by another method other than the method using the distance of the feature vector.

The model input unit 33 inputs each piece of image data extracted by the similar data extraction unit 32 to the prediction model being trained, and causes the prediction model to output a reliability regarding an instance included in an image represented by the image data. In particular, the model input unit 33 causes the prediction model to output the reliability of the instance determined to have a high similarity by the similar data extraction unit 32.

The data selection unit 34 selects at least a part of the image data extracted by the similar data extraction unit 32 as the image data for training. In the present embodiment, the data selection unit 34 selects, as the image data for training, the image data including an instance in which the reliability obtained by the model input unit 33 is within a predetermined range from the image data extracted by the similar data extraction unit 32.

In the present embodiment, the data selection unit 34 selects, as the image data for training, image data including an instance in which the reliability obtained by the model input unit 33 is equal to or less than a predetermined first reference value from the image data extracted by the similar data extraction unit 32. The first reference value is of relatively high reliability (e.g., on the order of 80% or 90%).

As a result, the image data including only the instance whose reliability is higher than the first reference value is not selected as the image data for training. As a result, image data including only instances that can be predicted relatively accurately by the prediction model is excluded from the image data for training. Therefore, the number of image data to be annotated by the user is reduced, the number of man-hours of the annotation is reduced, and the prediction model is trained by the image data including the instance which is not appropriately trained, so that the training efficiency can be improved.

In addition, in the present embodiment, the data selection unit 34 selects, as the image data for training, the image data including the instance in which the reliability obtained by the model input unit 33 is equal to or greater than the predetermined second reference value from the image data extracted by the similar data extraction unit 32. In particular, in the present embodiment, the data selection unit 34 selects image data including an instance whose reliability is within a range equal to or less than the first reference value and equal to or greater than the second reference value as image data for training. The second reference value has a relatively low reliability (e.g., on the order of 20% or 30%) and is less than the first reference value.

Accordingly, the image data including only the instance whose reliability is lower than the second reference value is not selected as the image data for training. Here, it is highly likely that an instance having an extremely low reliability is erroneously determined to be similar by the similar data extraction unit 32. Therefore, by excluding the image data including the instance having a low reliability, the image data including the instance determined to be mistakenly similar is excluded. As a result, the number of image data to be annotated by the user is reduced, the number of man-hours of the annotation is reduced, and the training efficiency can be improved by suppressing the training of the prediction model by the image data including an instance not necessarily suitable for the training.

In the present embodiment, the data selection unit 34 selects image data including an instance whose reliability is within a range equal to or less than the first reference value and equal to or greater than the second reference value as image data for training. However, the data selection unit 34 may select the image data including the instance whose reliability is within the range equal to or less than the first reference value as the image data for training. Alternatively, the data selection unit 34 may select the image data including the instance whose reliability is within the range equal to or greater than the second reference value as the image data for training. Alternatively, the data selection unit 34 may select all the image data extracted by the similar data extraction unit 32 as the image data for training regardless of the reliability.

The annotation unit 35 causes the user to annotate the image data selected by the data selection unit 34. The annotation unit 35 displays an image on an output device such as a display, and causes the user to input a ground truth value for an instance in the image via the input device. The annotation unit 35 collectively stores the image data and the input ground truth value in the storage unit 20 as training data.

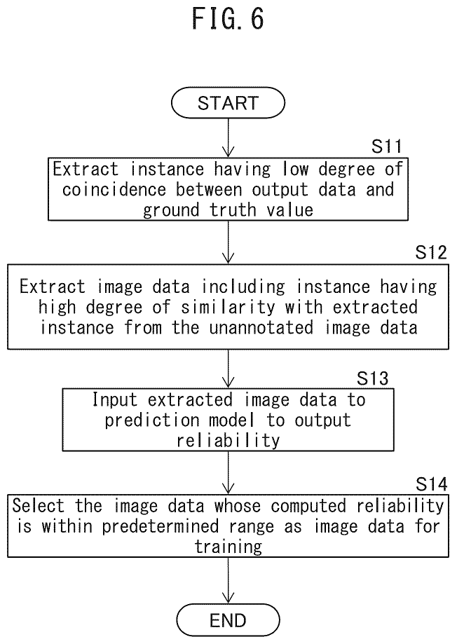

FIG. 6 is a flowchart illustrating a flow of a data selection process executed in the data selection device 1 according to the first embodiment. The data selection process illustrated in FIG. 6 is executed in the processor 30.

When the data selection process is started, the instance extraction unit 31 first inputs a plurality of pieces of annotated image data to the prediction model, and extracts instances in which the degree of coincidence between the output data output by the prediction model and the ground truth value is equal to or less than the reference value (step S11). Next, the similar data extraction unit 32 extracts image data including an instance having a degree of similarity equal to or greater than a predetermined value with the instance extracted by the instance extraction unit 31 from the plurality of unannotated image data that are candidates for the image data for training (step S12).

Next, the model input unit 33 inputs each piece of image data extracted by the similar data extraction unit 32 to the prediction model, and causes the model to output the reliability relating to the instance included in the image represented by the image data (step S13). Next, the data selection unit 34 selects image data including an instance whose reliability is within a range equal to or less than the first reference value and equal to or greater than the second reference value as image data for training (step S14).

### Second Embodiment

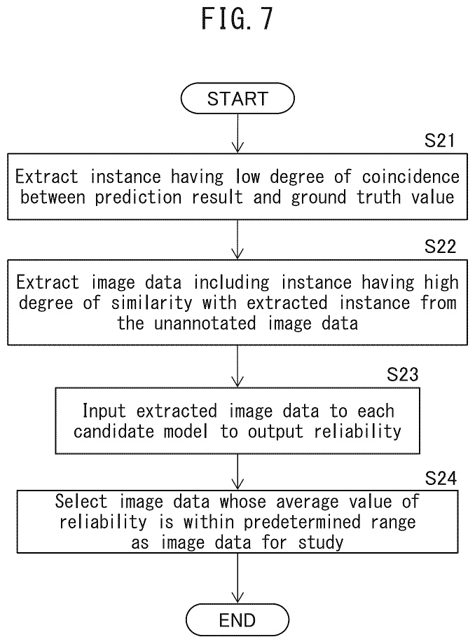

Next, the data selection device 1 according to the second embodiment will be described with reference to FIG. 7. The configuration and processing of the data selection device 1 according to the second embodiment are basically similar to those of the data selection device 1 according to the first embodiment. Hereinafter, a portion different from the data selection device according to the first embodiment will be mainly described.

In the first embodiment, the prediction model has only one model. On the other hand, in the second embodiment, the prediction model includes a plurality of candidate models in which the input parameter (image data) and the output parameter (prediction result such as reliability) are the same, and a configuration of the model or values of the parameters such as weights are different. Then, in the present embodiment, among the plurality of candidate models, a candidate model having a high accuracy of the prediction result is selected as a model to be finally used.

In the present embodiment, the model input unit 33 inputs each piece of image data extracted by the similar data extraction unit 32 to each candidate model being trained, and causes the model to output a reliability relating to an instance included in an image represented by the image data. That is, in the present embodiment, the model input unit 33 inputs each piece of image data extracted by the similar data extraction unit 32 to all candidate models to output the reliability.

In addition, in the present embodiment, the data selection unit 34 selects, as the image data for training, image data including an instance in which the average value of the reliability relating to the instances in all the candidate models obtained by the model input unit 33 is within a predetermined range (for example, within a range that is equal to or less than the first reference value and is equal to or greater than the second reference value). As a result, image data including an instance with low prediction accuracy on average is selected in all of the plurality of candidate models, and it is possible to efficiently train all of the plurality of candidate models.

Alternatively, the data selection unit 34 may select, as the image data for training, image data including an instance in which the reliability of the instance in at least one of the candidate models obtained by the model input unit 33 is within a predetermined range (for example, within a range that is equal to or less than the first reference value and is equal to or greater than the second reference value). As a result, image data including an instance with low prediction accuracy in at least one of the plurality of candidate models is selected, and the candidate model can be efficiently trained.

FIG. 7 is a flowchart illustrating a flow of data selection processing executed in the data selection device 1 according to the second embodiment. The data selection process illustrated in FIG. 7 is executed in the processor 30. Further, since the steps S21 and S22 in FIG. 7 are the same as the steps S11 and S12 in FIG. 6, the explanation thereof will be omitted.

When the similar data extraction unit 32 extracts the image data in step S22, the model input unit 33 inputs the respective pieces of image data extracted by the similar data extraction unit 32 to the respective candidate models, and cause the model to output the reliability relating to the instances included in the image represented by the image data (step S23). Next, the data selection unit 34 selects, as the image data for training, the image data including the instance in which the average value of the reliability of the instances in all the candidate models is within a range equal to or less than the first reference value and equal to or greater than the second reference value (step S24).

While embodiments according to the present disclosure have been described above, the present disclosure is not limited to these embodiments, and various modifications and changes can be made within the scope of the claims.

1. A data selection device for selecting image data for training of a prediction model which outputs data relating to an instance in an image represented by the image data when the image data is input, the data selection device comprising a processor,
the processor is configured to:
extract an instance whose degree of coincidence between output data of the prediction model when the annotated image data is input to the prediction model and a ground truth value regarding the instance of the annotated image data is equal to or less than a predetermined value;
extract image data including an instance whose similarity with the extracted instance is equal to or greater than a predetermined value from a plurality of pieces of image data which are not annotated and which is a candidate of image data for training; and
select at least a part of extracted image data as image data for training.

2. The data selection device according to claim 1, wherein
the prediction model is a model which outputs a prediction result regarding an instance in an image represented by the input image data and a reliability thereof, and
the processor is configured to:
input each extracted image data to the prediction model to output the reliability; and
select at least a part of image data including an instance whose reliability is equal to or less than a predetermined first reference value, as image data for training.

3. The data selection device according to claim 2, wherein
the processor is configured to select at least a part of image data including an instance whose reliability is equal to or less than the first predetermined reference value, and is equal to or greater than a second predetermined reference value, as image data for training, and
the first reference value is greater than the second reference value.

4. The data selection device according to claim 1, wherein
the prediction model has a plurality of candidate models which output a prediction result relating to an instance in an image represented by the input image data and reliability thereof,
the processor is configured to:
input each extracted image data to each candidate model to output the reliability, and
select, as the image data for training, image data including an instance in which an average value of obtained reliability in all the candidate models or a obtained reliability in at least one of the candidate models is within a predetermined range.

5. A non-transitory computer readable medium having recorded thereon a data selection program for selecting image data for training of a prediction model which outputs data relating to an instance in an image represented by the image data when the image data is input, the data selection program causing a computer to execute a process comprising:
extracting an instance whose degree of coincidence between output data of the prediction model when the annotated image data is input to the prediction model and a ground truth value regarding the instance of the annotated image data is equal to or less than a predetermined value;
extracting image data including an instance whose similarity with the extracted instance is equal to or greater than a predetermined value from a plurality of pieces of image data which are not annotated and which is a candidate of image data for training; and
selecting at least a part of extracted image data as image data for training.
